(19) United States
(12) Patent Application Publication
(10) Pub. No.: US 2026/0279300 A1
(43) Pub. Date: Sep. 17, 2026

(54) DISPLAY DEVICE with Shift Register

(71) Applicant: HannStar Display Corporation, Taipei City (TW)

(72) Inventors: Chien-Ting CHAN, Taipei City (TW); Cheng-Yen YEH, Taipei City (TW); Ling-Chih KAO, Taipei City (TW)

(21) Appl. No.: 19/312,342

(22) Filed: Aug. 28, 2025

(30) Foreign Application Priority Data
Mar. 14, 2025 (TW) 114109701

(51) Int. Cl. G09G 3/36; G09G 3/3266

(52) U.S. Cl. CPC G09G 3/3677; G09G 3/3266; G09G 2300/043; G09G 2310/0286; G09G 2310/061

(57) ABSTRACT

A display device includes a display panel and shift registers from a first level to an N^{th} level. An i^{th} level of the shift registers from the first level to the N^{th} level includes a pull-up unit driving stage, a pull-up unit, and a discharge unit. The pull-up unit driving stage receives first and second input signals, and outputs a pull-up driving signal via a first node. The pull-up unit receives the pull-up driving signal and plural clock signals, and outputs a scanning signal from the i^{th} level via a second node. The discharge unit receives the pull-up driving signal, and first and second discharge control signals. The first discharge control signal and the second discharge control signal switch between high and low voltage levels within every frame time of the display panel and at an end of every frame time of the display panel.

This application claims priority to Taiwan Application Serial Number 114109701, filed March 14, 2025, which is herein incorporated by reference in its entirety.

### BACKGROUND

### Field of Invention

The present invention relates to a display device, and more particularly to shift registers with adapted a compensation for threshold voltages and a narrow border display device featuring these shift registers.

### Description of Related Art

In recent years, panel manufacturers may integrate a gate circuit to the left and right edges of an array glass by the gate-on-array (GOA) method to reduce the number of display driver ICs (DDICs). However, as the panel resolution gets increasingly higher, the design of the above-described structure is prone to encountering the issue of the layout space being too large, which is not conducive to realizing a narrow border.

Furthermore, as the thin-film transistor (TFT) panel technology continues to advance, this includes the design of driver circuits that can be integrated into panels, such as the system on glass (SOG) method which may be accomplished by an amorphous silicon (a-Si) process. However, the threshold voltage (Vth) of the manufactured TFT component gradually rises because of the influence of the applied bias stress due to the limitations of process capability. In the prior art, the unstable phenomenon of threshold voltage shift occurs on multiple amorphous silicon thin-film transistors in the scanning shift circuit that uses the amorphous silicon thin-film transistor as the components, and the extent of the threshold voltage shift may seriously affect the normal operation of the scanning shift circuit, and even eventually cause the scanning shift circuit to fail as the usage time increases.

### SUMMARY

In one aspect of the present disclosure, a display device is provided, in which the display device achieves a narrow border effect in dual-gate and tri-gate panel driving technology through the configuration of each circuit component in a shift register. A capacitor of a pull-up unit of a shift register may be designed as a three-layer capacitor structure to increase the variability tolerance of a threshold voltage (Vth) of the shift register. Furthermore, a discharge control signal received by a discharge unit in the shift register may be designed to switch between high and low voltage levels within every frame time of the display panel and at the end of every frame time of the display panel to control the shift of the threshold voltage of components in the shift register, thus alleviating the aging of the threshold voltage. Therefore, the design may effectively improve the reliability of the shift register.

According to the above aspect, the present invention proposes a display device including a display panel and shift registers from a first level to an N^{th} level. The shift registers from the first level to the N^{th} level are configured to drive the display panel, in which an i^{th} level of the shift registers from the first level to the N^{th} level includes a pull-up unit driving stage, a pull-up unit, and a discharge unit. The pull-up unit driving stage receives a first input signal and a second input signal, and outputs a pull-up driving signal via a first node according to the first input signal and the second input signal. The pull-up unit is coupled to the pull-up unit driving stage. The pull-up unit receives the pull-up driving signal and plural clock signals, and outputs the scanning signal from the i^{th} level via a second node according to the pull-up driving signal and the clock signals. The discharge unit is coupled to the pull-up unit driving stage and the pull-up unit. The discharge unit receives the pull-up driving signal, a first discharge control signal, and a second discharge control signal, and controls whether to pull-down and keep the scanning signal from the i^{th} level at a reference potential according to the pull-up driving signal, the first discharge control signal, and the second discharge control signal. The first discharge control signal and the second discharge control signal switch between high and low voltage levels within every frame time of the display panel and at the end of every frame time of the display panel.

According to some embodiments of the present disclosure, a voltage switching time point of the second input signal is prior to a voltage switching time point of the first input signal within every frame time.

According to some embodiments of the present disclosure, a voltage switching time point of the second input signal is substantially the same as voltage switching time points of the first discharge control signal and the second discharge control signal within every frame time.

According to some embodiments of the present disclosure, the first discharge control signal and the second discharge control signal switching between high and low voltage levels within every frame time of the display panel and at the end of every frame time of the display panel includes the first discharge control signal and the second discharge control signal switching between high and low voltage levels at a first time point of the blanking period of every frame time of the display panel.

According to some embodiments of the present disclosure, the first discharge control signal and the second discharge control signal switching between high and low voltage levels within every frame time of the display panel and at the end of every frame time of the display panel ends includes the first discharge control signal or the second discharge control signal switching between high and low voltage levels at a second time point of the blanking period of every frame time of the display panel.

According to some embodiments of the present disclosure, a signal period of the clock signals is 12 data writing times, in which the data writing time is defined as the time spent by every one of the shift registers from the first level to the N^{th} level driving a corresponding pixel row of the display device within every frame time.

According to some embodiments of the present disclosure, a voltage switching time point of the first discharge control signal and a voltage switching time point of the second discharge control signal are about 2.5 microseconds apart.

According to some embodiments of the present disclosure, signal periods of the first discharge control signal and the second discharge control signal are about 2 seconds.

According to some embodiments of the present disclosure, there is a data holding time between the first discharge control signal and the scanning signal, from the i^{th} level or between the second discharge control signal and the scanning signal from the i^{th} level, and the data holding time is 2.5 microseconds.

According to another embodiment of the present disclosure, a signal period of the clock signals is 16 data writing times, in which the data writing time is defined as the time spent by every one of the shift registers from the first level to the N^{th} level driving a corresponding pixel row of the display device within every frame time.

According to another embodiment of the present disclosure, the display device includes a reset unit. The reset unit is coupled to the pull-up unit driving stage, the pull-up unit, and the discharge unit. The reset unit receives a reset signal, and resets voltage levels of the first node and the second node according to the reset signal after sequentially scanning the plural pixel columns within every frame time of the display panel.

According to another embodiment of the present disclosure, the reset unit includes a first transistor and a second transistor. The reset signal is input at a control terminal of the first transistor, a first terminal of the first transistor is coupled to the reference potential, and a second terminal of the first transistor is coupled to the first node. A control terminal of the second transistor is coupled to the control terminal of the first transistor, a first terminal of the second transistor is coupled to the reference potential, and a second terminal of the second transistor is coupled to the second node.

According to another embodiment of the present disclosure, voltage switching time points of the first discharge control signal and the second discharge control signal are after a voltage switching time point of the second input signal, and substantially the same as a voltage switching time point of the reset signal within every frame time when the i^{th} level of the shift registers are scanned forward.

According to another embodiment of the present disclosure, voltage switching time points of the first discharge control signal and the second discharge control signal are substantially the same as a voltage switching time point of the first input signal and substantially the same as a voltage switching time point of the reset signal within every frame time when the i^{th} level of the shift registers are scanned backward.

According to another embodiment of the present disclosure, a voltage switching time point of the first discharge control signal is substantially the same as a voltage switching time point of the reset signal within every frame time.

According to another embodiment of the present disclosure, the pull-up unit driving stage includes a third transistor and a fourth transistor. A control terminal of the third transistor receives the first input signal, a first terminal of the third transistor receives a forward input signal, and a second terminal of the third transistor outputs the pull-up driving signal. A control terminal of the fourth transistor receives the second input signal, a first terminal of the fourth transistor receives a backward input signal, and a second terminal of the fourth transistor is coupled to the second terminal of the third transistor.

According to another embodiment of the present disclosure, the pull-up unit includes a fifth transistor and a capacitor. A control terminal of the fifth transistor receives the pull-up driving signal, a first terminal of the fifth transistor receives the clock signals, and a second terminal of the fifth transistor outputs the scanning signal from the i^{th} level. A first terminal of the capacitor is coupled to the control terminal of the fifth transistor, and a second terminal of the capacitor is coupled to the second terminal of the fifth transistor.

According to another embodiment of the present disclosure, the capacitor includes a first metal layer, a second metal layer, a bottom electrode layer, and a top electrode layer. The second metal layer is located on the first metal layer, in which a first sub capacitor is formed between the first metal layer and the second metal layer. The bottom electrode layer is located on the first metal layer, in which a second sub capacitor is formed between the second metal layer and the bottom electrode layer. The top electrode layer is located on the bottom electrode layer, in which a third sub capacitor is located between the bottom electrode layer and the top electrode layer.

According to another embodiment of the present disclosure, the discharge unit includes a sixth transistor, a seventh transistor, an eighth transistor, a ninth transistor, and a tenth transistor. The first discharge control signal is input at a control terminal and a first terminal of the sixth transistor. The second discharge control signal is input at a control terminal of the seventh transistor, the reference potential is coupled to a first terminal of the seventh transistor, and a second terminal of the seventh transistor is coupled to the second terminal of the sixth transistor. A control terminal of the eighth transistor is coupled to a third node, and a first terminal of the eighth transistor is coupled to the reference potential. A control terminal of the ninth transistor is coupled to the third node, and a first terminal of the ninth transistor is coupled to the reference potential. A control terminal of the tenth transistor is coupled to the third node, and a second terminal of the tenth transistor is coupled to the reference potential.

According to another embodiment of the present disclosure, the display device has a dual-gate pixel array structure or a triple-gate pixel array structure.

### BRIEF DESCRIPTION OF THE DRAWINGS

For a more complete understanding of the embodiments and their advantages, refer to the following description in conjunction with the accompanying drawings, in which:

FIG. 1 is a schematic diagram of a scanning driver circuit and a display panel of a display device in accordance with some embodiments of the present disclosure.

FIG. 2A is an example of a driving method of the display panel of FIG. 1.

FIG. 2B is another example of the driving method of the display panel of FIG. 1.

FIG. 3A is an example of an equivalent circuit diagram of shift registers from an i^{th} level of FIG. 1.

FIG. 3B is another example of the equivalent circuit diagram of the shift registers from the i^{th} level of FIG. 1.

FIG. 4A is a cross-sectional view of a panel structure in the display panel of FIG. 1.

FIGS. 4B to 4D are top views of FIG. 4A at various stages.

FIG. 5 is a structural schematic diagram of a capacitor of FIG. 4A.

FIGS. 6A and 6B are an example of a forward time sequence diagram of the shift registers of FIG. 1.

FIGS. 6C and 6D are an example of a backward time sequence diagram of the shift registers of FIG. 1.

FIGS. 7A and 7B are another example of the forward time sequence diagram of the shift registers of FIG. 1.

FIGS. 7C and 7D are another example of the backward time sequence diagram of the shift registers of FIG. 1.

FIG. 8 is a voltage verse time diagram of discharge control signals of the shift registers from a first level to an N^{th} level of the scanning driver circuit of FIG. 1.

### DETAILED DESCRIPTION

The embodiments of the present disclosure are discussed in detail below. However, it should be understood that the embodiments provide many applicable concepts that can be implemented in a wide variety of specific contexts. The embodiments discussed and disclosed are for illustrative purposes only and are not intended to limit the scope of the present disclosure.

The terms used herein are intended only to describe particular embodiments and are not intended to limit the scope of the patent application. Unless otherwise specified, the terms “one” or “the” in singular form may also be used to denote the plural form.

It should be understand that while terms such as “first,” “second,” etc. are used herein to describe various features, these terms should not be used to limit these characteristics. These terms may only be used to distinguish one feature from another.

The spatially relative terms used herein are intended to encompass different orientations of the device in use or operation in addition to the orientation depicted in the figures. The components may be otherwise oriented (rotated 90 degrees or at other orientations) and the spatially relative descriptors used herein may likewise be interpreted accordingly.

For simplicity and clarity of illustration, component symbols and/or letters may be repeated herein in various embodiments, but this does not imply a causal relationship between the various embodiments and/or the configurations discussed herein. In addition, for simplicity and clarity of illustration of the technical features, the components in the drawings are not drawn to scale and the dimensions of the various components may be arbitrarily increased or decreased.

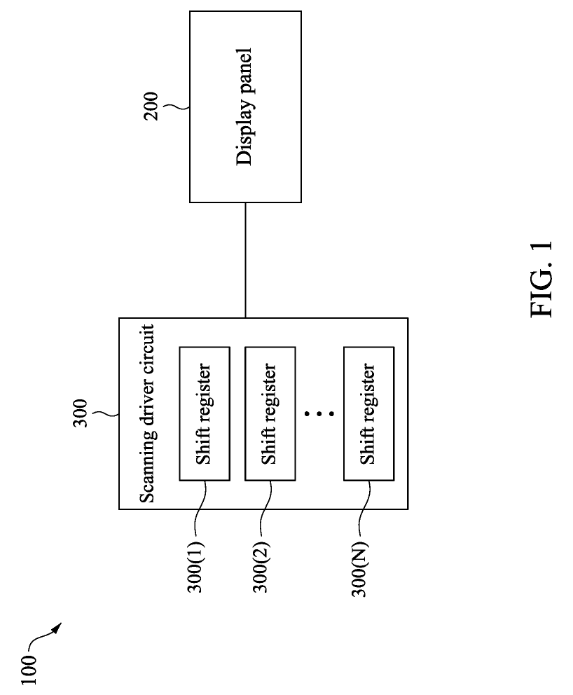

Reference is made to FIG. 1. FIG. 1 is a schematic diagram of a display device 100 in accordance with some embodiments of the present disclosure. The display device 100 may include a display panel 200 and a scanning driver circuit 300. The display panel 200 may be various types of liquid crystal display panels, such as a twisted nematic (TN) type, an in-plane switching (IPS) type, a fringe-field switching (FFS) type, or a vertical alignment (VA) type, or the display panel 200 may be an organic light-emitting diode (OLED) panel. In addition, the scanning driver circuit 300 in the present disclosure may also be a driver circuit of a reflective display panel, a transflective display panel, or a micro-transitive reflective display panel. The scanning driver circuit 300 includes shift registers 300(1)–300(N) from a first level to an N^{th} level that are electrically connected to the display panel 200, and configured to drive the display panel 200, in which N is a positive integer greater than or equal to 5. The shift registers 300(1)–300(N) from the first level to the N^{th} level may be gate on array (GOA) circuit structures.

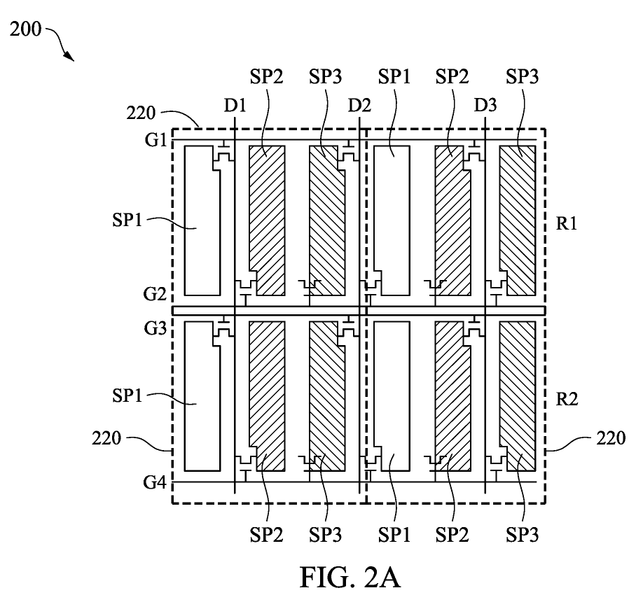

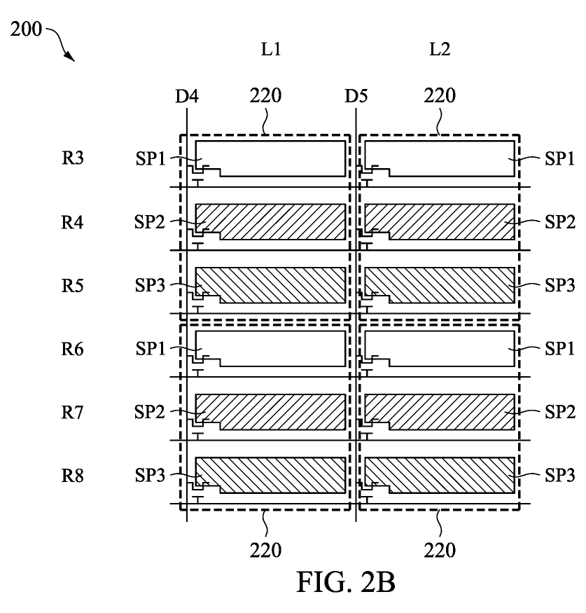

Reference is made to FIG. 2A. FIG. 2A is an example of a driving method of the display panel 200 of FIG. 1. The display panel 200 may have a dual-gate pixel array structure. In detail, the display panel 200 may include plural pixels 220, in which the pixels 220 include sub pixels SP1, SP2, and SP3, and the sub pixels SP1, SP2, and SP3 may display different colors, such as red, green, and blue. The sub pixels SP1, SP2, and SP3 may be designed to be arranged laterally. The sub pixels SP1 and SP2 share a data line D1, the sub pixels SP1 and SP3 share a data line D2, the sub pixels SP2 and SP3 share a data line D3, and the sub pixels SP1, SP2, or SP3 in a pixel row R1 may be respectively and electrically connected to a gate line G1 or G2. The sub pixels SP1, SP2, or SP3 in a pixel row R2 may be respectively and electrically connected to a gate line G3 or G4. Therefore, each pixel 220 may be electrically connected to two gate lines. Compared to the traditional driving method (such as a single-gate pixel array structure), the number of the data lines of the display panel 200 may be halved, and the number of the gate lines of the display panel 200 may be doubled, resulting in a twofold increase in the driving speed of the display panel 200.

Reference is made to FIG. 2B. FIG. 2B is another example of the driving method of the display panel 200 of FIG. 1. The display panel 200 may have a triple-gate pixel array structure. In detail, the display panel 200 may include plural pixels 220, in which the pixels 220 include sub pixels SP1, SP2, and SP3, and the sub pixels SP1, SP2, and SP3 may display different colors, such as red, green, and blue. The sub pixels SP1, SP2, and SP3 may be designed to be arranged vertically. The sub pixels SP1, SP2, and SP3 in each row share a data line D4 or D5. For example, the sub pixels SP1, SP2, and SP3 in a column L1 share the data line D4, and the sub pixels SP1, SP2, and SP3 in a column L2 share the data line D5. The sub pixels SP1, SP2, and SP3 may be respectively and electrically connected to different gate lines. For example, the sub pixels SP1 in rows R3 and R6 may be electrically connected to gate lines G5 and G8, the sub pixels SP2 in rows R4 and R7 may be electrically connected to gate lines G6 and G9, and the sub pixels SP3 in rows R5 and R8 may be electrically connected to gate lines G7 and G10. Therefore, each pixel 220 may be electrically connected to three gate lines. Compared to the traditional driving method (such as a single-gate pixel array structure), the number of the data lines of the display panel 200 may be reduced to one-third, resulting in a threefold increase in the driving speed of the display panel 200.

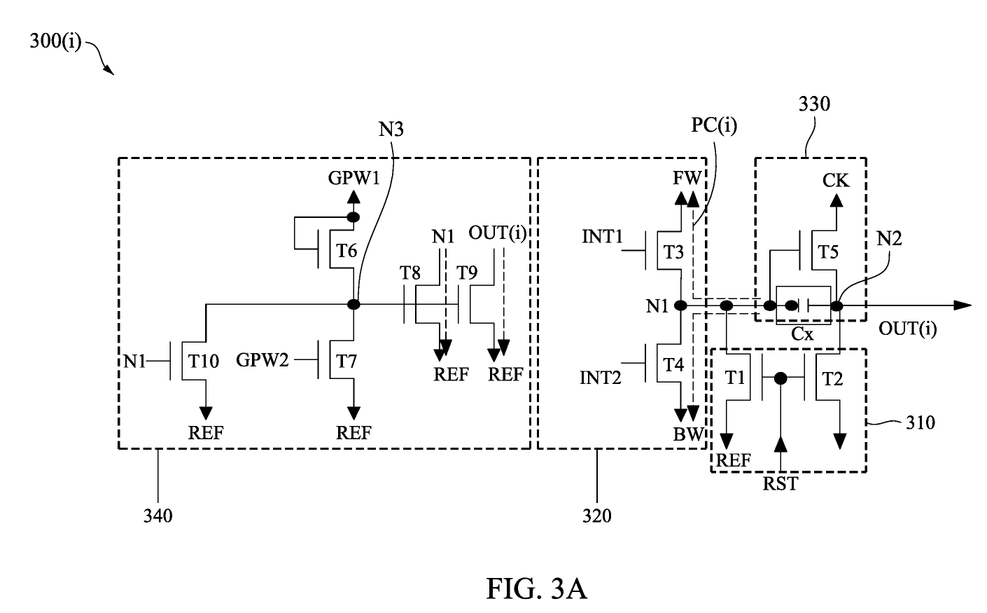

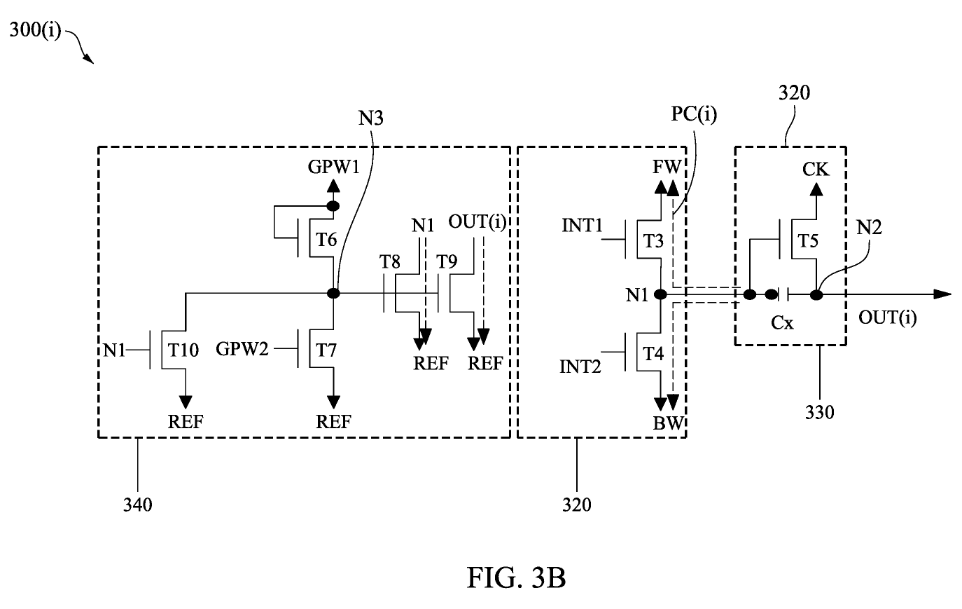

FIG. 3A is an example of an equivalent circuit diagram of a shift register 300(i) from an i^{th} level of FIG. 1, in which i is a positive integer from 1 to N. The shift register 300(i) from the i^{th} level includes a reset unit 310, a pull-up unit driving stage 320, a pull-up unit 330, and a discharge unit 340, in which one end of the reset unit 310, one end of the pull-up unit driving stage 320, one end of the pull-up unit 330, and one end of the discharge unit 340 are coupled to a node N1 (the node N1 corresponds to a pull-up unit driving signal PC(i)), and another end of the reset unit 310, another end of the pull-up unit 330, and another end of the discharge unit 340 are coupled to a node N2 (the node N2 corresponds to a scanning signal OUT(i) from the i^{th} level).

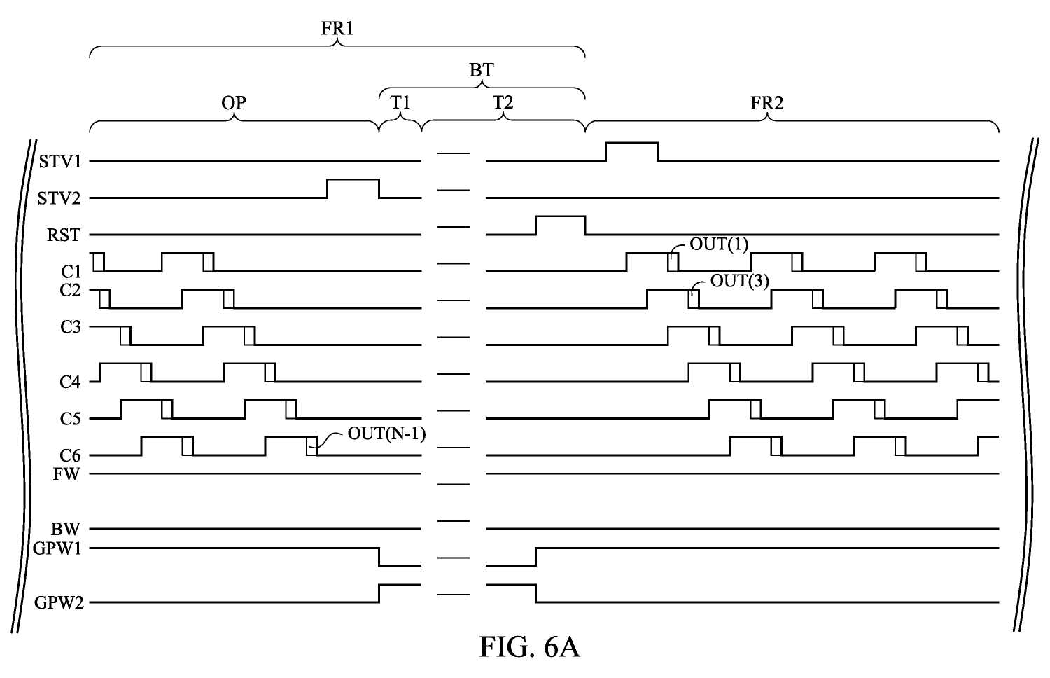

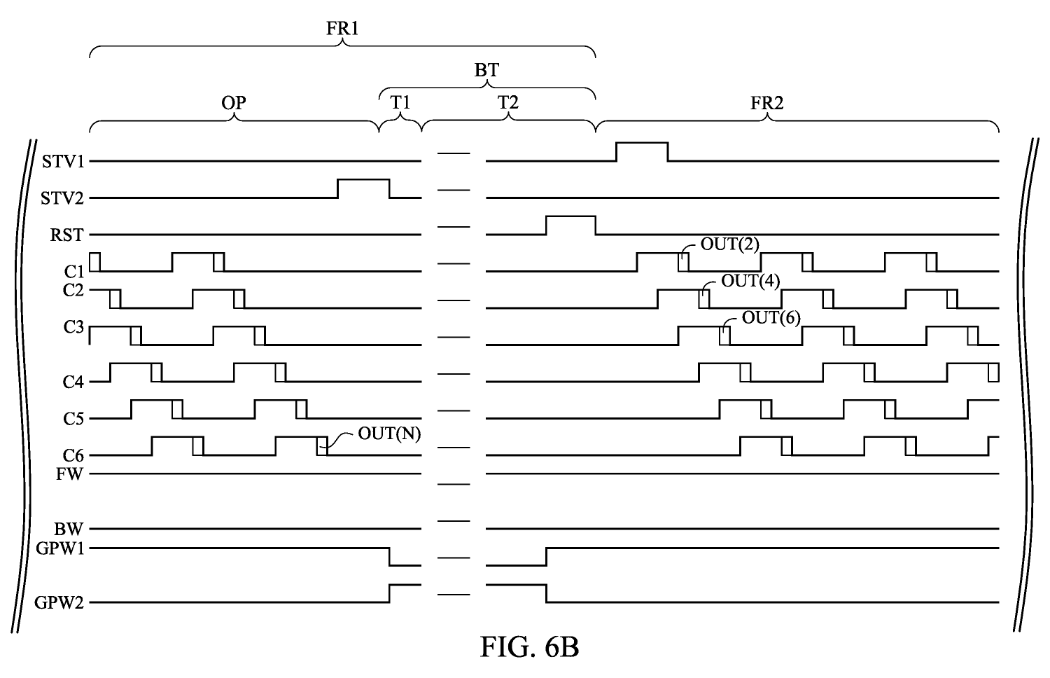

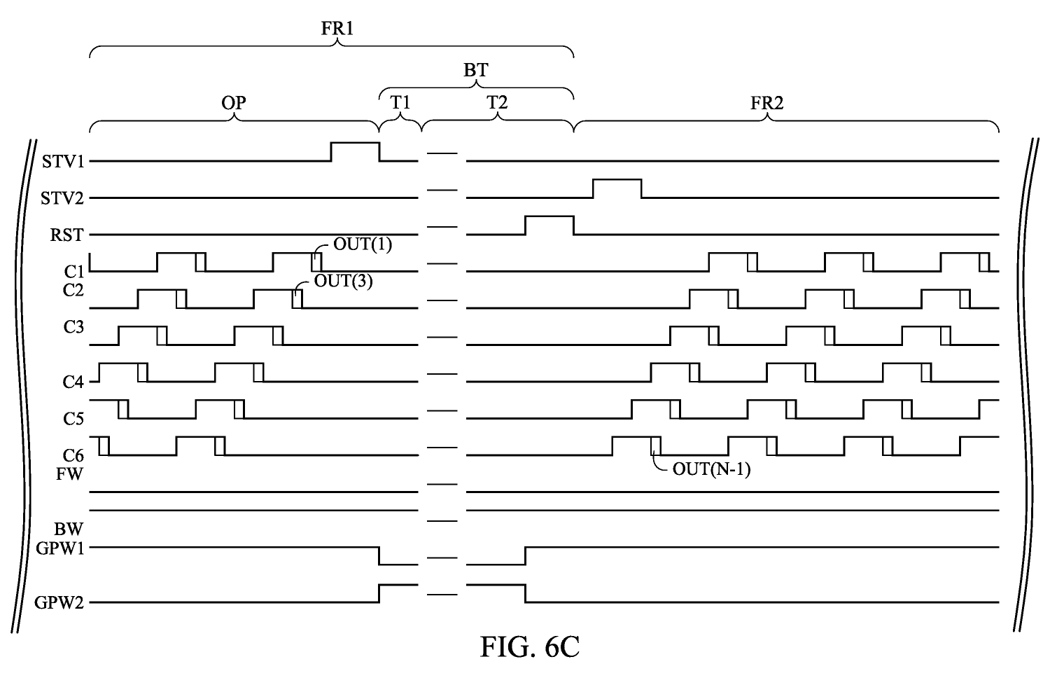

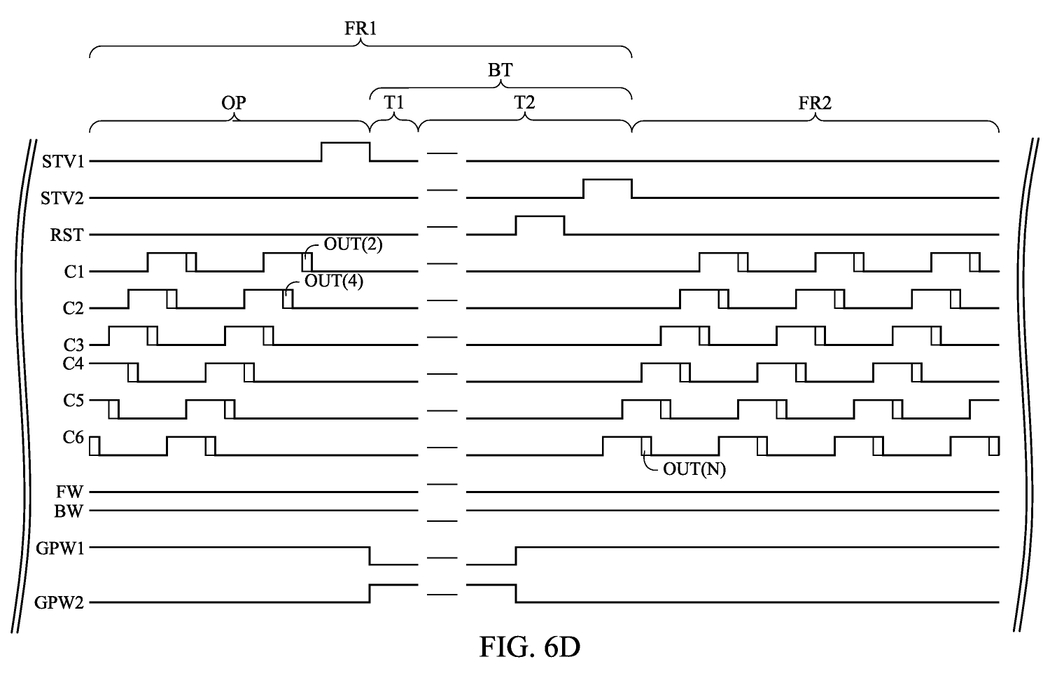

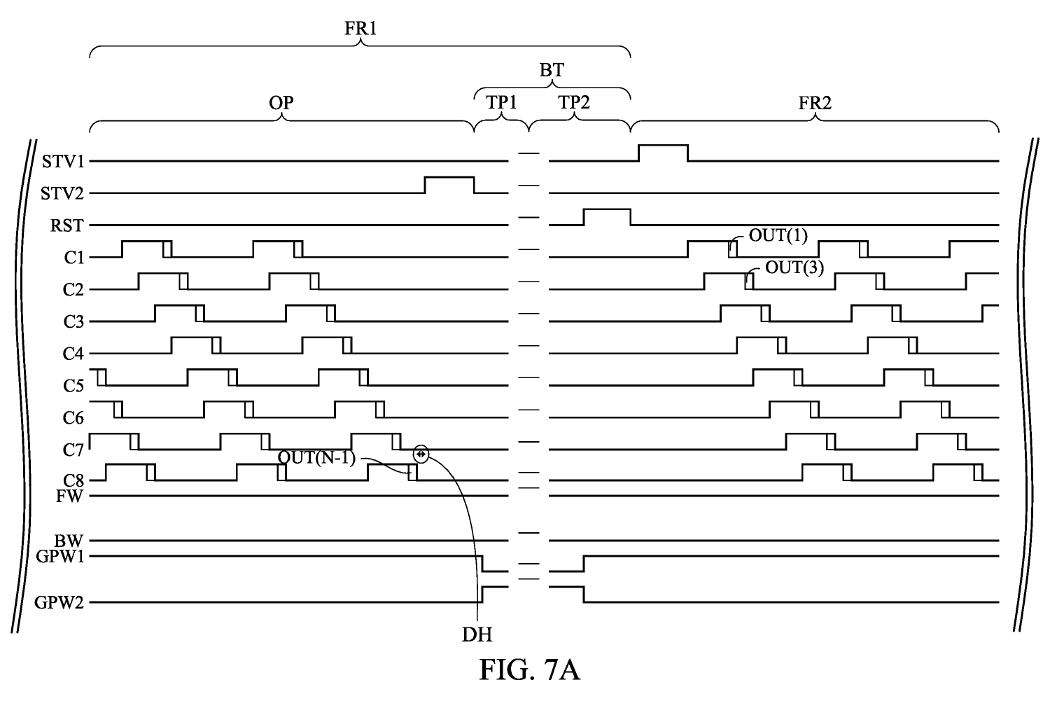

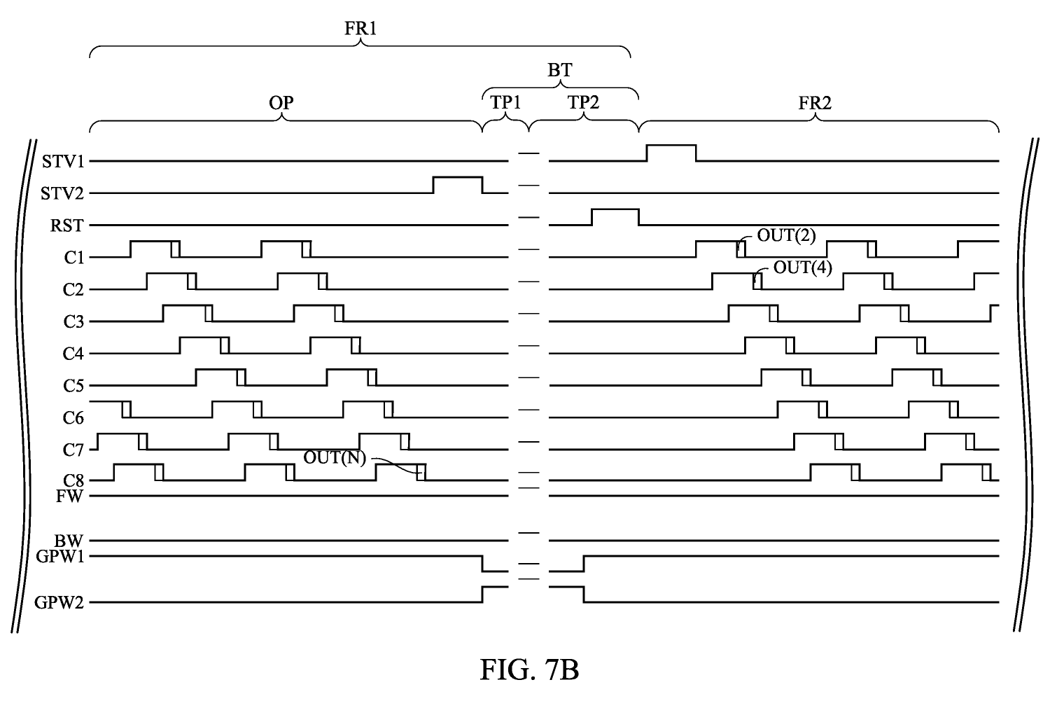

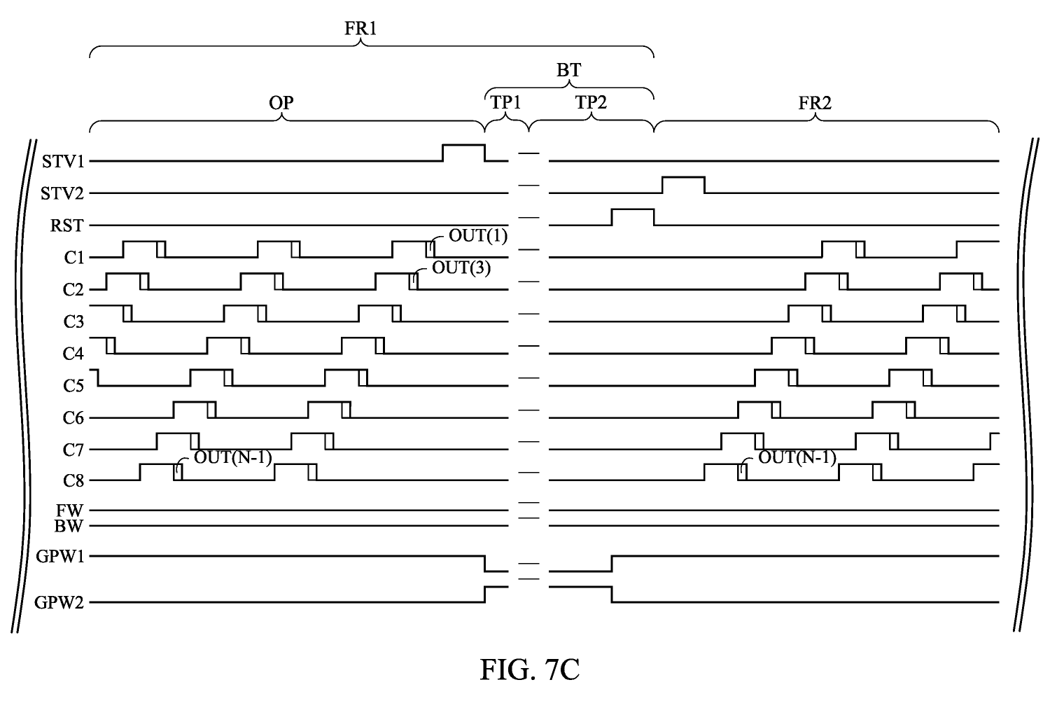

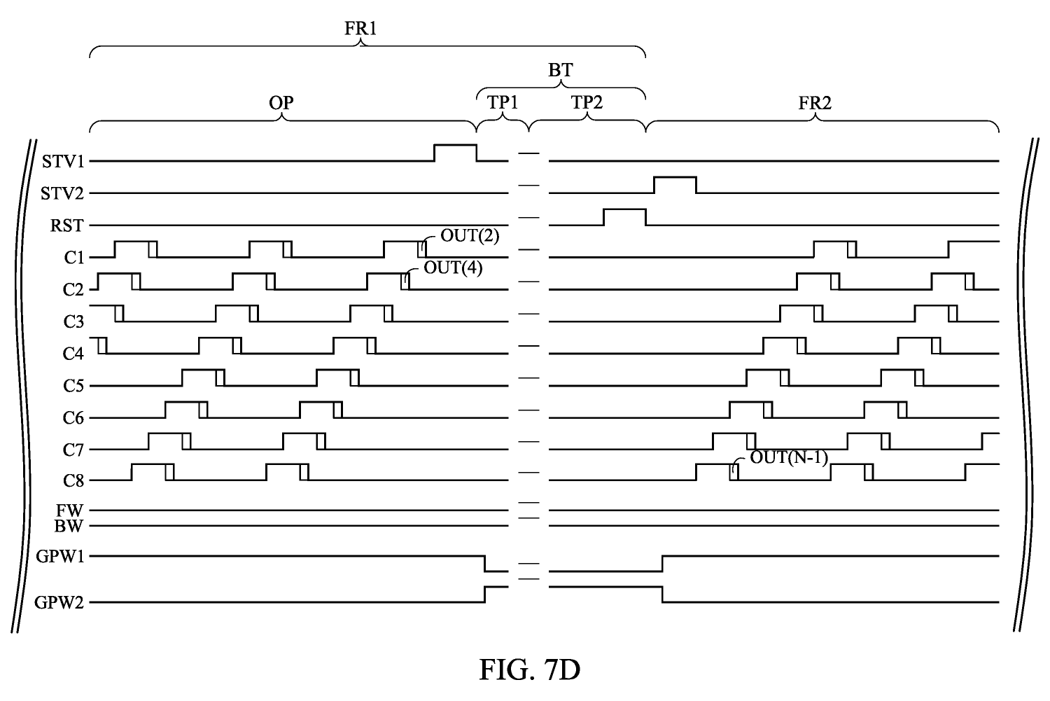

The reset unit 310 is coupled to the pull-up unit driving stage 320, the pull-up unit 330, and the discharge unit 340. The reset unit 310 receives a reset signal RST, and resets voltage levels of the node N1 and the node N2 according to the reset signal RST after sequentially scanning plural pixel columns of the display panel 200 within every frame time FR1 or FR2 (referring to FIGS. 6A to 7D) of the display panel 200. The reset unit 310 includes transistors T1 and T2. A control terminal of the transistor T1 receives the reset signal RST, a first terminal of the transistor T1 is coupled to a reference potential REF, and a second terminal of the transistor T1 is respectively coupled to the node N1. A control terminal of the transistor T2 is coupled to the control terminal of the transistor T1, a first terminal of the transistor T2 is coupled to the reference potential REF, and a second terminal of the transistor T2 is coupled to the node N2. The reference potential REF in the present embodiment is a gate low voltage (VGL), but is not limited to this example. In the present disclosure, “control terminal,” “first terminal,” and “second terminal” respectively correspond to a gate electrode, a source electrode, and a drain electrode of a transistor, or respectively correspond to the gate electrode, the drain electrode, and the source electrode of the transistor.

The pull-up unit driving stage 320 is coupled to the reset unit 310 and the pull-up unit 330. The pull-up unit driving stage 320 receives input signals INT1 and INT2, and outputs a pull-up driving signal PC (i) via the node N1 according to the input signals INT1 and INT2. The pull-up unit driving stage 320 includes transistors T3 and T4. A control terminal of the transistor T3 receives the input signal INT1, a first terminal of the transistor T3 receives a forward input signal FW, and a second terminal of the transistor T3 outputs the pull-up driving signal PC (i). A control terminal of the transistor T4 receives the input signal INT2, a first terminal of the transistor T4 receives a backward input signal BW, and a second terminal of the transistor T4 is coupled to the second terminal of the transistor T3. The shift registers 300(1)–300(N) from the first level to the N^{th} level may perform a forward scan or a backward scan on the display panel 200 according to the voltage switching states of the forward input signal FW and the backward input signal BW.

If the shift register 300(i) from the i^{th} level of the shift registers 300(1)–300(N) from the first level to the N^{th} level is one of the shift registers 300(1)–300(4) from the first level to the fourth level (i.e., i is 1, 2, 3, or 4), the input signal INT1 is a start signal, and the input signal INT2 is an output signal OUT(i+4) (such as output signal OUT(7) from a seventh level or output signal OUT(8) from an eighth level) outputted by a shift register 300(i+4) from an i+4^{th} level. If the shift register 300(i) from the i^{th} level is one of the shift registers 300(5)–300(N-2) from the fifth level to the N-2^{th} level (i.e., i is any integer from 5 to N-2), the input signals INT1 and INT2 are respectively an output signal OUT (i-6) from an i-6^{th} level outputted by a shift register 300(i-6) from an i-6^{th} level and an output signal OUT (i+2) from an i+2^{th} level outputted by a shift register 300(i+2) from an i+2^{th} level. If the shift register 300(i) from the i^{th} level is a shift registers 300(N-1) from an N-1^{th} level or a shift registers 300(N) from an N^{th} level (i.e., i is N-1 or N), the input signal INT1 is an output signal OUT (i-5) outputted by a shift register 300(i-5) from an i-5^{th} level (i.e., an output signal OUT (N-5) from an N-5^{th} level or an output signal OUT (N-4) from an N-4^{th} level), and the input signal INT2 is the end signal.

It is worth mentioning that when the shift register 300(i) from the i^{th} level of the shift registers 300(1)–300(N) from the first level to the N^{th} level performs the forward scan, that is, the forward input signal FW is at a high voltage level, and the backward input signal BW is at a low voltage level, a signal STV1 is the start signal, and a signal STV2 is the end signal. When the shift register 300(i) from the i^{th} level of the shift registers 300(1)–300(N) from the first level to the N^{th} level performs the backward scan, that is, the forward input signal FW is at the low voltage level, and the backward input signal BW is at the high voltage level, the signal STV2 is the start signal, and the signal STV1 is the end signal.

The pull-up unit 330 is coupled to the pull-up unit driving stage 320. The pull-up unit 330 receives the pull-up driving signal PC (i) and plural clock signals CK, and outputs a scanning signal OUT (i) from the i^{th} level via the node N2 according to the pull-up driving signal PC (i) and the clock signals CK, in which the clock signals CK are any one of clock signals C1–C6 or any one of clock signals C1–C8. The pull-up unit 330 includes a transistor T5 and a capacitor Cx. A control terminal of the transistor T5 receives the pull-up driving signal PC (i), a first terminal of the transistor T5 receives the clock signal CK, and a second terminal of the transistor T5 outputs the scanning signal OUT (i) from the i^{th} level. A first terminal of the capacitor Cx is coupled to the control terminal of the transistor T5, and a second terminal of the capacitor Cx is coupled to the second terminal of the transistor T5.

The discharge unit 340 is coupled to the pull-up unit driving stage 320 and the pull-up unit 330. The discharge unit 340 receives the pull-up driving signal PC (i), and discharge control signals GPW1, GPW2, and controls whether to pull-down and keep the scanning signal OUT (i) from the i^{th} level at the reference potential REF according to the pull-up driving signal PC (i), and the discharge control signals GPW1, GPW2. The discharge unit 340 includes transistors T6–T10. The discharge control signal GPW1 is input at a control terminal and a first terminal of the transistor T6, and a second terminal of the transistor T6 is coupled to a node N3. The discharge control signal GPW2 is input at a control terminal of the transistor T7, the reference potential REF is coupled to a first terminal of the transistor T7, and a second terminal of the transistor T7 is coupled to the second terminal of the transistor T6. A control terminal of the transistor T8 is coupled to the node N3, and a first terminal of the transistor T8 is coupled to the reference potential REF. A control terminal of the transistor T9 is coupled to the node N3, and a first terminal of the ninth transistor T9 is coupled to the reference potential REF, and a second terminal of the ninth transistor T9 receives the scanning signal OUT (i) from the i^{th} level. A control terminal of the transistor T10 is coupled to the node N3, and a second terminal of the transistor T10 is coupled to the reference potential REF.

Reference is made to FIG. 3B. FIG. 3B is another example of the equivalent circuit diagram of the shift register 300(i) from the i^{th} level of FIG. 1, in which i is a positive integer from 1 to N. The example of FIG. 3B is similar to FIG. 3A. The difference between the example of FIGS. 3B and 3A is as, as shown in FIG. 3B, the shift register 300(i) from the i^{th} level does not include the reset unit 210. Other features are similar to the example in FIG. 3A and are not repeated herein.

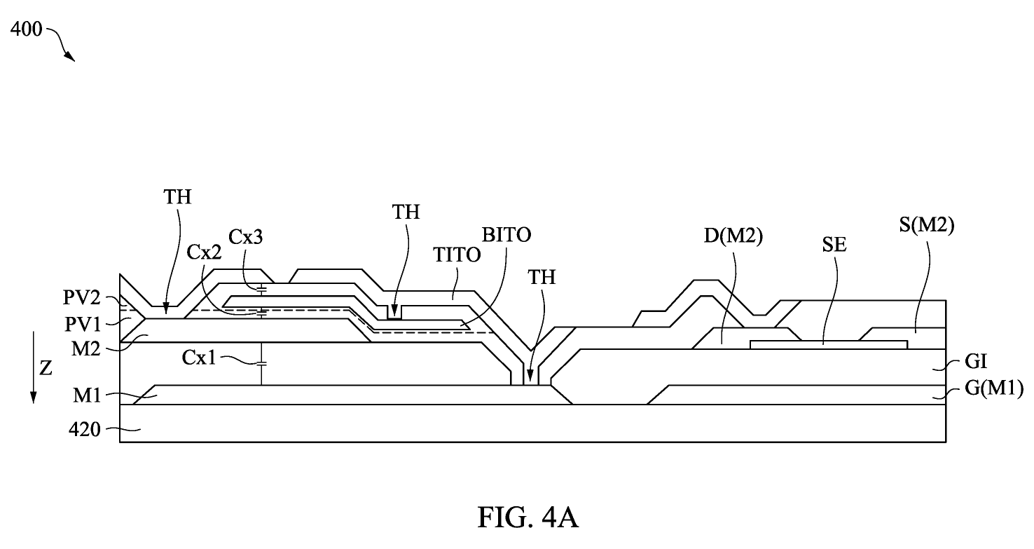

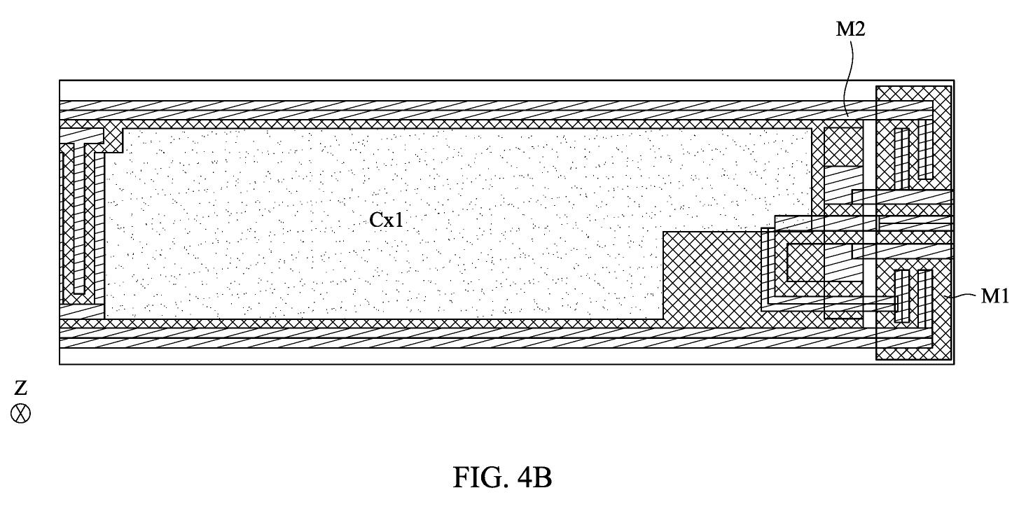

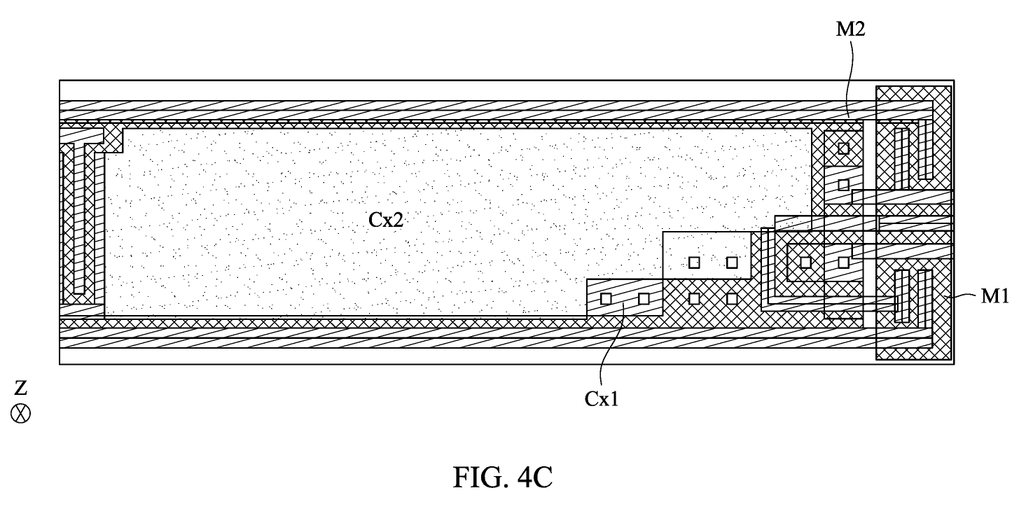

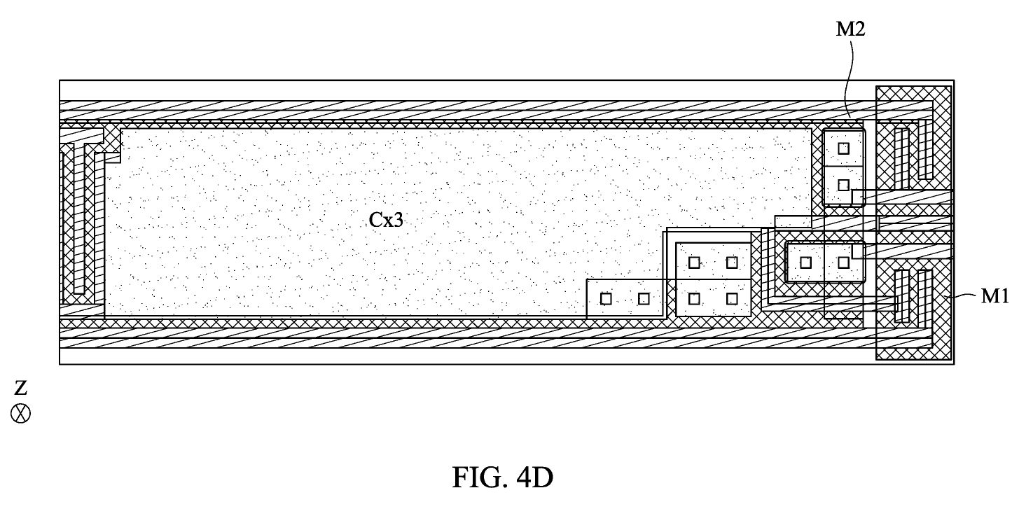

Reference is made to FIGS. 4A to 4D. FIG. 4A is a cross-sectional view of a panel structure 400 in the display panel 200 of FIG. 1, and FIGS. 4B to 4D are top views of FIG. 4A at various stages. The panel structure 400 includes a first metal layer M1, a gate insulation layer GI, a semiconductor layer SE, a second metal layer M2, a first insulation layer PV1, a bottom electrode layer BITO, a second insulation layer PV2, and a top electrode layer TITO sequentially disposed on the substrate 420.

The first metal layer M1 may be made of copper, aluminum, molybdenum, chromium, and/or another suitable material, and formed by processes, such as film formation, exposure, and etching. In addition, the first metal layer M1 may be a stacked layer formed by multiple conductive material layers, such as a film layer formed by three layers of a conductive material, such as indium tin oxide, silver, and indium tin oxide, sequentially stacked. The gate insulation layer GI may be made of inorganic materials, such as silicon nitride or other suitable materials, and the gate insulation layer GI may be formed on the first metal layer M1 by processes, such as film formation. The semiconductor layer SE may be an undoped semiconductor or a doped semiconductor, in which the materials of the undoped semiconductor may be an amorphous silicon, a monocrystalline silicon, a polycrystalline silicon, or other suitable materials, and the materials of the doped semiconductor may correspond to a doped amorphous silicon, a doped monocrystalline silicon, a doped polycrystalline silicon, or other suitable materials. The semiconductor layer SE may be formed on the gate insulation layer GI by processes, such as film formation, exposure, and etching. The second metal layer M2 may be made of copper, aluminum, molybdenum, chromium, and/or other suitable materials. Similarly, the second metal layer M2 may be a stacked layer formed by multiple conductive material layers, such as a film layer formed by three layers of a conductive material, such as indium tin oxide, silver, and indium tin oxide, sequentially stacked, and the second metal layer M2 may be formed on the gate insulation layer GI and the semiconductor layer SE by processes, such as film formation, exposure, and etching, in which the first metal layer M1 includes a gate G, the second metal layer M2 includes a source S and a drain D, and a part of the gate G and the gate insulation layer GI, the semiconductor layer SE, the source S and the drain D form a thin film transistor (TFT), and the fabrication process for the TFT may include, but is not limited to, an amorphous silicon (a-Si) process, a low-temperature polycrystalline silicon (LTPS) process, an oxide TFT process, an indium gallium zinc oxide (IGZO) TFT process, or a so-called low temperature polycrystalline oxide (LTPO) process (a combination of LTPS and IGZO). The first insulation layer PV1 may be made of inorganic insulation materials, such as silicon nitride, silicon oxynitride, a combination thereof, and/or other suitable materials. In other embodiments, the first insulation layer PV1 may be made of organic insulation materials, such as acrylic, siloxane, polyimide, epoxy resin, a combination thereof, and/or other suitable materials. The first insulation layer PV1 may be formed on the second metal layer M2 by processes, such as film formation. The bottom electrode layer BITO may be made of indium tin oxide (ITO), indium zinc oxide (IZO), antimony tin oxide (ATO), fluorine tin oxide (FTO), tin oxide, zinc oxide, graphene, a combination thereof, and/or other suitable transparent conductive materials, and the bottom electrode layer BITO may be formed on the first insulation layer PV1 by processes, such as film formation, exposure, and etching. The second insulation layer PV2 may be made of inorganic insulation materials, such as silicon nitride, silicon oxynitride, a combination thereof, and/or other suitable materials. In other embodiments, the second insulation layer PV2 may be made of organic insulation materials, such as acrylic, siloxane, polyimide, epoxy resin, a combination thereof, and/or other suitable materials. The second insulation layer PV2 may be formed on the bottom electrode layer BITO by processes, such as film formation, exposure, and etching. The top electrode layer TITO may be made of indium tin oxide, indium zinc oxide, antimony tin oxide, fluorine tin oxide, tin oxide, zinc oxide, graphene, a combination thereof, and/or other suitable transparent conductive materials, and the top electrode layer TITO may be formed on the second insulation layer PV2 by processes, such as film formation, exposure, and etching. The top electrode layer TITO may be in contact with and electrically connected to parts of the components of the first metal layer M1, the second metal layer M2, and the bottom electrode layer BITO.

It is worth mentioning that the second metal layer M2 is disposed on the first metal layer M1 along the direction Z and overlaps the first metal layer M1 along the direction Z. Therefore the first metal layer M1, the second metal layer M2, and the gate insulation layer GI between the first metal layer M1 and the second metal layer M2 form a sub capacitor Cx1. The bottom electrode layer BITO is disposed on the second metal layer M2 along the direction Z and overlaps the second metal layer M2 along the direction Z. Therefore the bottom electrode layer BITO, the second metal layer M2, and the first insulation layer PV1 between the bottom electrode layer BITO and the second metal layer M2 form a sub capacitor Cx2. The top electrode layer TITO is disposed on the bottom electrode layer BITO along the direction Z and overlaps the bottom electrode layer BITO along the direction Z. Therefore the top electrode layer TITO, the bottom electrode layer BITO, and the second insulation layer PV2 between the top electrode layer TITO and the bottom electrode layer BITO form a sub capacitor Cx3.

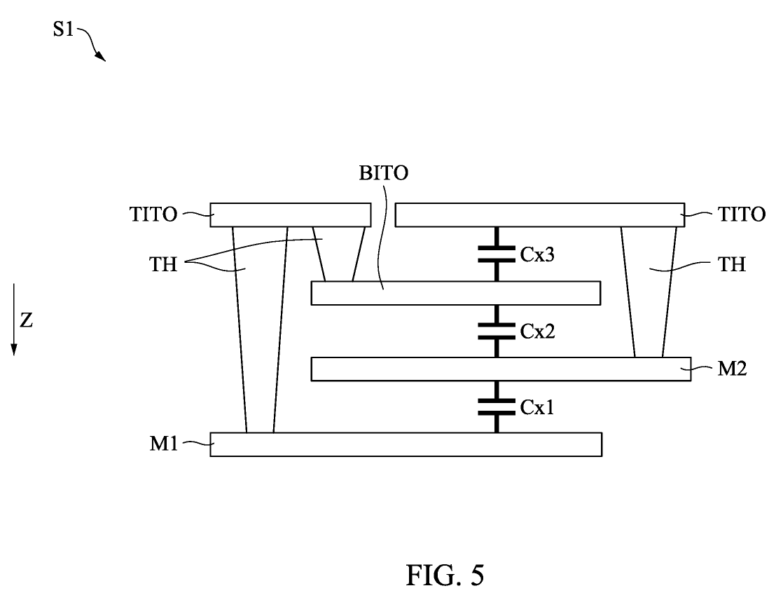

Reference is made to FIG. 5. FIG. 5 is a structural schematic diagram of the capacitor Cx of FIG. 4A, in which FIG. 5 only illustrates a parallel structure S1 of the first metal layer M1, the second metal layer M2, the first insulation layer PV1, the bottom electrode layer BITO, the second insulation layer PV2, and the top electrode layer TITO for ease of explanation of the capacitor Cx of the present invention. In the present embodiment, the second insulation layer PV2 may include plural through-hole structures TH, allowing the first metal layer M1, the second metal layer M2, the bottom electrode layer BITO, and the top electrode layer TITO to conduct electrically by the through-hole structures TH, in which the bottom electrode layer BITO and the top electrode layer TITO respectively receive a common signal and a pixel signal. In greater detail, in the sub capacitor Cx2, the bottom electrode layer BITO may first contact the top electrode layer TITO, and then the first metal layer M1, allowing the sub capacitor Cx2 to be electrically connected to the sub capacitor Cx1. In the sub capacitor Cx3, the top electrode layer TITO may contact the second metal layer M2, allowing the sub capacitor Cx3 to be electrically connected to the sub capacitor Cx2. Therefore, the capacitor Cx may be formed by paralleling the sub capacitors Cx1, Cx2, and Cx3, and the capacitor Cx may store voltage changes between the common signal and the pixel signal. Furthermore, the capacitor Cx is designed as the parallel structure S1 with three layers of capacitors, such that the variability tolerance of a threshold voltage (Vth) of the shift register 300(i) from the i^{th} level can be increased.

Reference is made to FIGS. 6A and 6B. FIGS. 6A and 6B are an example of a forward time sequence diagram of the shift registers 300(1)–300(N) from the first level to the N^{th} level of FIG. 1, in which FIG. 6A illustrates a rightward scan, and FIG. 6B illustrates a leftward scan. The equivalent circuit diagram of the shift registers 300(1)–300(N) from the first level to the N^{th} level is as shown in FIG. 3A or FIG. 3B. In the present embodiment, the equivalent circuit diagram of FIG. 3A is used as an example, and the equivalent circuit diagram of FIG. 3B may be inferred and is not described to avoid redundancy.

As shown in FIGS. 6A and 6B, the shift registers 300(1)–300(N) from the first level to the N^{th} level perform the forward scan. The forward input signal FW s at a gate high voltage (VGH), and the backward input signal BW keeps at the gate low voltage (VGL), allowing the gate on array circuit structure to discharge in an operation period OP of the frame time FR1. At the same time, the clock signals C1–C6 sequentially rise to the high voltage level, allowing the corresponding scanning signals OUT(1)–OUT(N) from the first level to the N^{th} level to rise to the high voltage level. The clock signals C1–C6 sequentially drop to the low voltage level, allowing the corresponding scanning signals OUT(N-i)–OUT(N) from the N-i^{th} level to the N^{th} level to drop to the low voltage level. The signal period of the clock signals C1–C6 is 12 data writing times, in which the data writing time is defined as the time spent by every one of the shift registers 300(1)–300(N) from the first level to the N^{th} level driving a corresponding pixel row of the display panel 200 within every frame time. It is worth mentioning that the high voltage level of the clock signals C1–C6 is maintained for 5 data writing times, the low voltage level of the clock signals C1–C6 is maintained for 7 data writing times, and one data writing time is required between the clock signals C1 and C4, the clock signals C2 and C5, and the clock signals C3 and C6.

The signal STV2 performs a voltage level switch after the scanning signals OUT(1)–OUT(N) from the first level to the N^{th} level sequentially rise to the high voltage level and drop to the low voltage level, and a voltage switching time point of the signal STV2 is prior to voltage switching time points of the signal STV1 and the reset signal RST within every frame time, in which the signal STV2 is the end signal. For example, the signal STV2 rises to the high voltage level and drops to the low voltage level to complete the data input in the frame time FR1 in the operation period OP of the frame time FR1 and before entering a time point TP1 of a blanking period BT, in which the high voltage level of the signal STV2 is maintained for 5 data writing times.

Subsequently, the blanking period BT of the frame time FR1 is entered. The reset signal RST performs a voltage level switch at a time point TP2 of the blanking period BT of the frame time FR1, in which the voltage switching time point of the reset signal RST is prior to the voltage switching time point of the signal STV1. For example, the reset signal RST rises from the low voltage level to the high voltage level to conduct the transistors T1 and T2, thus resetting the voltage levels of the nodes N1 and N2 of every one of the shift registers 300(1)–300(N) from the first level to the N^{th} level to the low voltage level at the time point TP2 of the blanking period BT of the frame time FR1, and the reset signal RST drops from the high voltage level to the low voltage level after resetting the voltage levels of the nodes N1 and N2, in which the high voltage level of the reset signal RST is maintained for 5 data writing times.

Subsequently, the frame time FR2 is entered. The signal STV1 rises from the low voltage level to the high voltage level, and the clock signals C1–C6 sequentially rise to the high voltage level, allowing the corresponding scanning signals OUT(1)–OUT(N) from the first level to the N^{th} level to rise to the high voltage level. The clock signals C1–C6 sequentially drop to the low voltage level, allowing the corresponding scanning signals OUT(1)–OUT(N) from the first level to the N^{th} level to drop to the low voltage level, in which the high voltage level of the signal STV1 is maintained for 5 data writing times, and the signal STV1 drops to the low voltage level before the clock signal C1 drops from the high voltage level to the low voltage level. The time sequences of the clock signals C1–C6, the signal STV2, the reset signal RST, the signal STV1, and the scanning signals OUT(1)–OUT(N) from the first level to the N^{th} level are the same as the time sequence in the frame time FR1 during the subsequent period of the frame time FR2.

It is worth mentioning that the discharge control signals GPW1 and GPW2 switch between high and low voltage levels within every frame time of the display panel 200 and at the end of every frame time of the display panel 200, in which the discharge control signals GPW1 and GPW2 are in opposite phases within every frame time, meaning that one of the discharge control signals GPW1 and GPW2 is at the high voltage level, while the other is at the low voltage level. In detail, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a first time point of the blanking period of every frame time of the display panel 200. For example, the discharge control signal GPW1 may switch from the gate high voltage (VGH) to the gate low voltage (VGL), and the discharge control signal GPW2 may switch from the gate low voltage (VGL) to the gate high voltage (VGH) at the time point TP1 of the blanking period BT of the frame time FR1, in which the voltage switching time point of the discharge control signal GPW1 is substantially the same as the voltage switching time points of the discharge control signal GPW2, and the voltage switching time points of the discharge control signal GPW1 and GPW2 are substantially the same as the voltage switching time point of the signal STV2 dropping from the high voltage level to the low voltage level. Furthermore, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a second time point of the blanking period of every frame time of the display panel 200. For example, the discharge control signal GPW1 may switch from the gate low voltage (VGL) to the gate high voltage (VGH), and the discharge control signal GPW2 may switch from the gate high voltage (VGH) to the gate low voltage (VGL) at the time point TP2 of the blanking period BT of the frame time FR1, in which the voltage switching time point of the discharge control signal GPW1 is substantially the same as the voltage switching time points of the discharge control signal GPW2, and the voltage switching time points of the discharge control signal GPW1 and GPW2 are substantially the same as the voltage switching time point of the reset signal RST rising from the low voltage level to the high voltage level.

Reference is made to FIGS. 6C and 6D. FIGS. 6C and 6D are an example of a backward time sequence diagram of the shift registers 300(1)–300(N) from the first level to the N^{th} level of FIG. 1, in which FIG. 6C illustrates a rightward scan, and FIG. 6D illustrates a leftward scan. The equivalent circuit diagram of the shift registers 300(1)–300(N) from the first level to the N^{th} level is as shown in FIG. 3A or FIG. 3B. In the present embodiment, the equivalent circuit diagram of FIG. 3A is used as an example, and the equivalent circuit diagram of FIG. 3B may be inferred and is not described to avoid redundancy.

As shown in FIGS. 6C and 6D, the shift registers 300(1)–300(N) from the first level to the N^{th} level perform the backward scan. The forward input signal FW keeps at the gate low voltage (VGL), and the backward input signal BW keeps at the gate high voltage (VGH), allowing the gate on array circuit structure to discharge in the operation period OP of the frame time FR1. At the same time, the clock signals C6–C1 sequentially rise to the high voltage level, allowing the corresponding scanning signals OUT(N)–OUT(1) from the N^{th} level to the first level to rise to the high voltage level. The clock signals C6–C1 sequentially drop to the low voltage level, allowing the corresponding scanning signals OUT(N)–OUT(1) from the N^{th} level to the first level to drop to the low voltage level. The signal period of the clock signals C6–C1 is 12 data writing times, in which the data writing time is defined as the time spent by every one of the shift registers 300(1)–300(N) from the first level to the N^{th} level driving a corresponding pixel row of the display panel 200 within every frame time. It is worth mentioning that the high voltage level of the clock signals C6–C1 is maintained for 5 data writing times, the low voltage level of the clock signals C6–C1 is maintained for 7 data writing times, and one data writing time is required between the clock signals C1 and C4, the clock signals C2 and C5, and the clock signals C3 and C6.

The signal STV1 performs a voltage level switch after the scanning signals OUT(N)–OUT(1) from the N^{th} level to the first level sequentially rise to the high voltage level and drop to the low voltage level, and the voltage switching time point of the signal STV1 is prior to the voltage switching time points of the signal STV2 and the reset signal RST within every frame time, in which the signal STV1 is the end signal. For example, the signal STV1 rises from the low voltage to the high voltage level and drops from the high voltage level to the low voltage level to complete the data input in the frame time FR1 in the operation period OP of the frame time FR1 and before entering the time point TP1 of the blanking period BT, in which the high voltage level of the signal STV1 is maintained for 5 data writing times.

Subsequently, the blanking period BT of the frame time FR1 is entered. The reset signal RST performs a voltage level switch at the time point TP2 of the blanking period BT of the frame time FR1, in which the voltage switching time point of the reset signal RST is prior to the voltage switching time point of the signal STV2. For example, the reset signal RST rises from the low voltage level to the high voltage level to conduct the transistors T1 and T2, thus resetting the voltage levels of the nodes N1 and N2 of every one of the shift registers 300(1)–300(N) from the first level to the N^{th} level to the low voltage level at the time point TP2 of the blanking period BT of the frame time FR1, and the reset signal RST drops from the high voltage level to the low voltage level after resetting the voltage levels of the nodes N1 and N2, in which the high voltage level of the reset signal RST is maintained for 5 data writing times.

Subsequently, the frame time FR2 is entered. The signal STV2 rises from the low voltage level to the high voltage level, the clock signals C6–C1 sequentially rise to the high voltage level, allowing the corresponding scanning signals OUT(N)–OUT(1) from the N^{th} level to the first level to rise to the high voltage level. The clock signals C6–C1 sequentially drop to the low voltage level, allowing the corresponding scanning signals OUT(N)–OUT(1) from the N^{th} level to the first level to drop to the low voltage level, in which the high voltage level of the signal STV2 is maintained for 5 data writing times, and the signal STV2 substantially drops to the low voltage level before the clock signal C6 drops from the high voltage level to the low voltage level. The time sequences of the clock signals C6–C1, the signal STV1, the reset signal RST, the signal STV2, and the scanning signals OUT(N)–OUT(1) from the N^{th} level to the first level are the same as the time sequence in the frame time FR1 during the subsequent period of the frame time FR2.

It is worth mentioning that the discharge control signals GPW1 and GPW2 switch between high and low voltage levels within every frame time of the display panel 200 and at the end of every frame time of the display panel 200, in which the discharge control signals GPW1 and GPW2 are in opposite phases within every frame time, meaning that one of the discharge control signals GPW1 and GPW2 is at the high voltage level, while the other is at the low voltage level. In detail, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a first time point of the blanking period of every frame time of the display panel 200. For example, the discharge control signal GPW1 may switch from the gate high voltage (VGH) to the gate low voltage (VGL), and the discharge control signal GPW2 may switch from the gate low voltage (VGL) to the gate high voltage (VGH) at the time point TP1 of the blanking period BT of the frame time FR1, in which the voltage switching time point of the discharge control signal GPW1 is substantially the same as the voltage switching time points of the discharge control signal GPW2, and the voltage switching time points of the discharge control signal GPW1 and GPW2 are substantially the same as the voltage switching time point of the signal STV1 dropping from the high voltage level to the low voltage level. Furthermore, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a second time point of the blanking period of every frame time of the display panel 200. For example, the discharge control signal GPW1 may switch from the gate low voltage (VGL) to the gate high voltage (VGH), and the discharge control signal GPW2 may switch from the gate high voltage (VGH) to the gate low voltage (VGL) at the time point TP2 of the blanking period BT of the frame time FR1, in which the voltage switching time point of the discharge control signal GPW1 is substantially the same as the voltage switching time points of the discharge control signal GPW2, and the voltage switching time points of the discharge control signal GPW1 and GPW2 are substantially the same as the voltage switching time point of the reset signal RST rising from the low voltage level to the high voltage level.

Reference is made to FIGS. 7A and 7B. FIGS. 7A and 7B are another example of the forward time sequence diagram of the shift registers 300(1)–300(N) from the first level to the N^{th} level of FIG. 1, in which FIG. 7A illustrates a rightward scan, and FIG. 7B illustrates a leftward scan. The equivalent circuit diagram of the shift registers 300(1)–300(N) from the first level to the N^{th} level is as shown in FIGS. 3A or 3B. In the present embodiment, the equivalent circuit diagram of FIG. 3A is used as an example, and the equivalent circuit diagram of FIG. 3B may be inferred and is not described to avoid redundancy.

As shown in FIGS. 7A and 7B, the shift registers 300(1)–300(N) from the first level to the N^{th} level perform the forward scan. The forward input signal FW keeps at the gate high voltage (VGH), and the backward input signal BW keeps at the gate low voltage (VGL), allowing the gate on array circuit structure to discharge in the operation period OP of the frame time FR1. At the same time, the clock signals C1–C8 sequentially rise to the high voltage level, allowing the corresponding scanning signals OUT(1)–OUT(N) from the first level to the N^{th} level to rise to the high voltage level. The clock signals C1–C8 sequentially drop to the low voltage level, allowing the corresponding scanning signals OUT(1)–OUT(N) from the first level to the N^{th} level to drop to the low voltage level. The signal period of the clock signals C1–C8 is 16 data writing times, in which the data writing time is defined as the time spent by every one of the shift registers 300(1)–300(N) from the first level to the N^{th} level driving a corresponding pixel row of the display panel 200 within every frame time. It is worth mentioning that the high voltage level of the clock signals C1–C8 is maintained for 6 data writing times, the low voltage level of the clock signals C1–C8 is maintained for 10 data writing times, and one data writing time is required between the clock signals C1 and C4, the clock signals C2 and C5, and the clock signals C3 and C6.

The signal STV2 performs a voltage level switch after the scanning signals OUT(1)–OUT(N) from the first level to the N^{th} level sequentially rise to the high voltage level and drop to the low voltage level, and the voltage switching time point of the signal STV2 is prior to the voltage switching time points of the signal STV1 and the reset signal RST within every frame time, in which the signal STV2 is the end signal. For example, the signal STV2 rises to the high voltage level and drops to the low voltage level to complete the data input in the frame time FR1 in the operation period OP of the frame time FR1 and before entering the time point TP1 of the blanking period BT, in which the high voltage level of the signal STV2 is maintained for 6 data writing times.

Subsequently, the blanking period BT of the frame time FR1 is entered. The reset signal RST performs a voltage level switch at the time point TP2 of the blanking period BT of the frame time FR1, in which the voltage switching time point of the reset signal RST is prior to the voltage switching time point of the signal STV1. For example, the reset signal RST rises from the low voltage level to the high voltage level to conduct the transistors T1 and T2, thus resetting the voltage levels of the nodes N1 and N2 of every one of the shift registers 300(1)–300(N) from the first level to the N^{th} level to the low voltage level at the time point TP2 of the blanking period BT of the frame time FR1, and the reset signal RST drops from the high voltage level to the low voltage level after resetting the voltage levels of the nodes N1 and N2, in which the high voltage level of the reset signal RST is maintained for 6 data writing times.

Subsequently, the frame time FR2 is entered. The signal STV1 rises from the low voltage level to the high voltage level, and drops from the high voltage to the low voltage at a time separated by one data writing time from the voltage switching time point of the reset signal RST dropping from the high voltage to the low voltage, in which the high voltage level of the signal STV1 is maintained for 6 data writing times, and the signal STV1 substantially drops from the high voltage to the low voltage before the clock signal C1 drops from the high voltage to the low voltage. Subsequently, the clock signals C1–C8 sequentially rise to the high voltage level, allowing the corresponding scanning signals OUT(1)–OUT(N) from the first level to the N^{th} level to rise to the high voltage level in the frame time FR2, in which the frame time FR2 begins simultaneously with the scanning signal OUT(1) from the first level rising to the high voltage level. Subsequently, the clock signals C1–C8 sequentially drop to the low voltage level, allowing the corresponding scanning signals OUT(1)–OUT(N) from the first level to the N^{th} level to drop to the low voltage level. The time sequences of the clock signals C1–C8, the signal STV2, the reset signal RST, the signal STV1, and the scanning signals OUT(1)–OUT(N) from the first level to the N^{th} level are the same as the time sequence in the frame time FR1 during the subsequent period of the frame time FR2.

It is worth mentioning that the discharge control signals GPW1 and GPW2 switch between high and low voltage levels within every frame time of the display panel 200 and at the end of every frame time of the display panel 200, in which the discharge control signals GPW1 and GPW2 are in opposite phases within every frame time, meaning that one of the discharge control signals GPW1 and GPW2 is at the high voltage level, while the other is at the low voltage level. In detail, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a first time point of the blanking period of every frame time of the display panel 200. For example, the discharge control signal GPW1 may switch from the gate high voltage (VGH) to the gate low voltage (VGL), and the discharge control signal GPW2 may switch from the gate low voltage (VGL) to the gate high voltage (VGH) at the time point TP1 of the blanking period BT of the frame time FR1, and the voltage switching time points of the discharge control signal GPW1 and GPW2 are after the voltage switching time point of the signal STV2 dropping from the high voltage level to the low voltage level, in which the signal periods of the discharge control signal GPW1 and GPW2 are about 2 seconds. Furthermore, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a second time point of the blanking period of every frame time of the display panel 200. For example, the discharge control signal GPW1 may switch from the gate low voltage (VGL) to the gate high voltage (VGH), and the discharge control signal GPW2 may switch from the gate high voltage (VGH) to the gate low voltage (VGL) at the time point TP2 of the blanking period BT of the frame time FR1. The voltage switching time points of the discharge control signals GPW1 and GPW2 are substantially the same as the voltage switching time point of the reset signal RST rising from the low voltage level to the high voltage level. In addition, there is a data holding time DH1 between the discharge control signal GPW1 and the scanning signal OUT(N) from the N^{th} level, or between the discharge control signal GPW2 and the scanning signal OUT(N) from the N^{th} level, in which the data holding time DH1 is 2.5 microseconds.

In another embodiment, the voltage switching time point of the discharge control signal GPW1 may be about 2.5 microseconds apart from the voltage switching time point of the discharge control signal GPW2.

Reference is made to FIGS. 7C and 7D. FIGS. 7C and 7D are another example of the backward time sequence diagram of the shift registers 300(1)–300(N) from the first level to the N^{th} level of FIG. 1, in which FIG. 7C illustrates a rightward scan, and FIG. 7D illustrates a leftward scan. The equivalent circuit diagram of the shift registers 300(1)–300(N) from the first level to the N^{th} level is as shown in FIG. 3A or FIG. 3B. In the present embodiment, the equivalent circuit diagram of FIG. 3A is used as an example, and the equivalent circuit diagram of FIG. 3B may be inferred and is not described to avoid redundancy.

As shown in FIGS. 7C and 7B, the shift registers 300(1)–300(N) from the first level to the N^{th} level perform the backward scan. The forward input signal FW keeps at the gate low voltage (VGL), and the backward input signal BW keeps at the gate high voltage (VGH), allowing the gate on array circuit structure to discharge in the operation period OP of the frame time FR1. At the same time, the clock signals C8–C1 sequentially rise to the high voltage level, allowing the corresponding scanning signals OUT(N)–OUT(1) from the N^{th} level to the first level to rise to the high voltage level. The clock signals C8–C1 sequentially drop to the low voltage level, allowing the corresponding scanning signals OUT(N)–OUT(1) from the N^{th} level to the first level to drop to the low voltage level. The signal period of the clock signals C8–C1 is 16 data writing times, in which the data writing time is defined as the time spent by every one of the shift registers 300(1)–300(N) from the first level to the N^{th} level driving a corresponding pixel row of the display panel 200 within every frame time. It is worth mentioning that the high voltage level of the clock signals C8–C1 is maintained for 5 data writing times, and the low voltage level of the clock signals C8–C1 is maintained for 11 data writing times.

The signal STV1 performs a voltage level switch after the scanning signals OUT(N)–OUT(1) from the N^{th} level to the first level sequentially rise to the high voltage level and drop to the low voltage level, and the voltage switching time point of the signal STV1 is prior to the voltage switching time points of the signal STV2 and the reset signal RST within every frame time, in which the signal STV1 is the end signal. For example, the signal STV1 rises to the high voltage level and drops to the low voltage level to complete the data input in the frame time FR1 in the operation period OP of the frame time FR1 and before entering the time point TP1 of the blanking period BT, in which the high voltage level of the signal STV1 is maintained for 5 data writing times.

Subsequently, the blanking period BT of the frame time FR1 is entered. The reset signal RST performs a voltage level switch at the time point TP2 of the blanking period BT of the frame time FR1, in which the voltage switching time point of the reset signal RST is prior to the voltage switching time point of the signal STV2. For example, the reset signal RST rises from the low voltage level to the high voltage level to conduct the transistors T1 and T2, thus resetting the voltage levels of the nodes N1 and N2 of every one of the shift registers 300(1)–300(N) from the first level to the N^{th} level to the low voltage level at the time point TP2 of the blanking period BT of the frame time FR1, and the reset signal RST drops from the high voltage level to the low voltage level after resetting the voltage levels of the nodes N1 and N2, in which the high voltage level of the reset signal RST is maintained for 5 data writing times.

Subsequently, the frame time FR2 is entered. The signal STV2 rises from the low voltage level to the high voltage level at a time separated by one data writing time from the voltage switching time point of the reset signal RST dropping from the high voltage to the low voltage, in which the high voltage level of the signal STV2 is maintained for 5 data writing times, and the signal STV2 substantially drops from the high voltage to the low voltage before the clock signal C8 drops from the high voltage to the low voltage. Subsequently, the clock signals C8–C1 sequentially rise to the high voltage level, allowing the corresponding scanning signals OUT(N)–OUT(1) from the N^{th} level to the first level to rise to the high voltage level in the frame time FR2, and the clock signals C8–C1 sequentially drop to the low voltage level, allowing the corresponding scanning signals OUT(N)–OUT(1) from the N^{th} level to the first level to drop to the low voltage level. The time sequences of the clock signals C8–C1, the signal STV1, the reset signal RST, the signal STV2, and the scanning signals OUT(N)–OUT(1) from the N^{th} level to the first level are the same as the time sequence in the frame time FR1 during the subsequent period of the frame time FR2.

It is worth mentioning that the discharge control signals GPW1 and GPW2 switch between high and low voltage levels within every frame time of the display panel 200 and at the end of every frame time of the display panel 200, in which the discharge control signals GPW1 and GPW2 are in opposite phases within every frame time, meaning that one of the discharge control signals GPW1 and GPW2 is at the high voltage level, while the other is at the low voltage level. In detail, the discharge control signals GPW1 and GPW2 switching between high and low voltage levels within every frame time of the display panel 200 and at the end of every frame time of the display panel 200 includes the discharge control signal GPW1 or GPW2 switching between high and low voltage levels at a first time point of the blanking period of every frame time of the display panel 200. For example, the discharge control signal GPW1 may switch from the gate high voltage (VGH) to the gate low voltage (VGL), and the discharge control signal GPW2 may switch from the gate low voltage (VGL) to the gate high voltage (VGH) at the time point TP1 of the blanking period BT of the frame time FR1, in which the signal periods of the discharge control signal GPW2 are about 2 seconds. The voltage switching time points of the discharge control signal GPW1 or GPW2 are substantially the same as the voltage switching time point of the signal STV1 dropping from the high voltage level to the low voltage level. Furthermore, the discharge control signals GPW1 and GPW2 switch between high and low voltage levels within every frame time of the display panel 200 and at the end of every frame time of the display panel 200 ends includes the discharge control signal GPW1 or GPW2 switching between high and low voltage levels at a second time point of the blanking period of every frame time of the display panel 200. For example, the discharge control signal GPW1 may switch from the gate low voltage (VGL) to the gate high voltage (VGH), and the discharge control signal GPW2 may switch from the gate high voltage (VGH) to the gate low voltage (VGL) at the time point TP2 of the blanking period BT of the frame time FR1, in which the voltage switching time points of the discharge control signal GPW1 is substantially the same as the voltage switching time point of the discharge control signal GPW2, and the voltage switching time points of the discharge control signals GPW1 and GPW2 are substantially the same as the voltage switching time point of the reset signal RST rising from the low voltage level to the high voltage level. In addition, there is a data holding time DH2 between the discharge control signal GPW1 and the scanning signal OUT(N) from the N^{th} level, or between the discharge control signal GPW2 and the scanning signal OUT(N) from the N^{th} level, in which the data holding time DH2 is 2.5 microseconds. In another embodiment, the voltage switching time point of the discharge control signal GPW1 may be about 2.5 microseconds apart from the voltage switching time point of the discharge control signal GPW2.

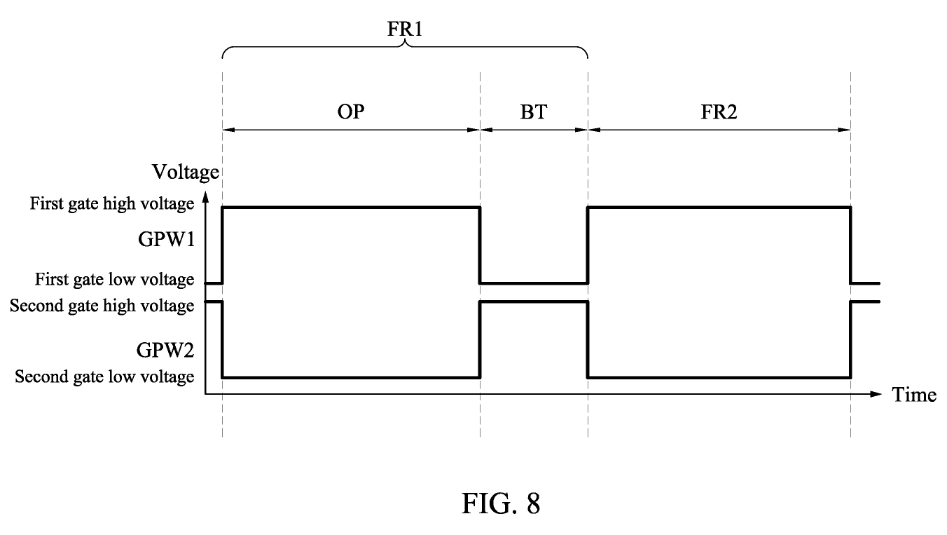

Reference is made to FIG. 8. FIG. 8 is a voltage verse time diagram of the discharge control signals GPW1 and GPW2 of the shift registers 300(1)–300(N) from the first level to the N^{th} level of the scanning driver circuit 300 of FIG. 1. In the prior art, the unstable phenomenon of threshold voltage shift (Vth shift) occurs on multiple thin-film transistor components in the scanning shift circuit if a positive bias or a negative bias is continuously applied to the thin-film transistor components to drive the thin-film transistor components. For example, the threshold voltages of the multiple thin-film transistor components of the shift registers in the scanning shift circuit may gradually shift to the right if the positive bias is continuously applied to drive the thin-film transistor components. In other words, the threshold voltages of the thin-film transistor components increase. The threshold voltages of the multiple thin-film transistor components of the shift registers in the scanning shift circuit may gradually shift to the left if the negative bias is continuously applied to drive the thin-film transistor components. In other words, the threshold voltages of the thin-film transistor components decrease. However, the extent of the threshold voltage shift may seriously affect the normal operation of the scanning shift circuit. For example, the increased threshold voltage makes the thin-film transistor components harder to conduct, and the decreased threshold voltage makes the thin-film transistor components harder to turn off, which in turn causes issues such as insufficient driving current or excessive leakage current.

Therefore, to avoid the issues described above, the scanning driver circuit 300 may adopt a driving method for automatically compensating the threshold voltages. For example, the discharge control signal GPW1 is first applied with the first gate high voltage (VGH) and then applied with the first gate low voltage (VGL), and the discharge control signal GPW2 is first applied with the second gate high voltage (VGH) and then applied with the second gate low voltage (VGL). Other voltage implementation methods may be inferred, and are not repeated. In detail, the discharge control signal GPW1 may be continuously applied with the first gate high voltage (VGH), and the discharge control signal GPW2 may be continuously applied with the second gate low voltage (VGL) to make the node N3 positively biased in the operation period OP of the frame time FR1, allowing the threshold voltages of the transistors T8 and T9 to gradually shift to the right. In other words, the threshold voltages of the transistors T8 and T9 gradually increase in the operation period OP of the frame time FR1. The discharge control signal GPW1 may be continuously applied with the first gate low voltage (VGL), and the discharge control signal GPW2 may be continuously applied with the second gate high voltage (VGH) to make the node N3 negatively biased (such as the reference potential REF) in the blanking period BT of the frame time FR1, allowing the threshold voltages of the transistors T8 and T9 to gradually shift to the left. In other words, the threshold voltages of the transistors T8 and T9 gradually decrease from the larger threshold voltages in the blanking period BT of the frame time FR1, allowing the threshold voltages of the transistors T8 and T9 to be automatically compensated. Therefore, the threshold voltage shifts of the transistors T8 and T9 may be mitigated by the voltage level changes of the discharge control signal GPW1, the discharge control signal GPW2, and the node N3 to effectively improve the reliability of the scanning driver circuit 300. The voltage level changes of the discharge control signals GPW1 and GPW2 in the frame time FR2 are the same as the voltage level changes of the discharge control signals GPW1 and GPW2 in the frame time FR1, and therefore are not repeated herein.

In summary, the display devices in the present invention achieve a narrow border effect in dual-gate and tri-gate panel driving technology through the configuration of each circuit component in the shift register. The capacitor of the pull-up unit of the shift register may be designed as a three-layer capacitor structure to increase the variability tolerance of the threshold voltage (Vth) of the shift register. Furthermore, the discharge control signal received by the discharge unit in the shift register may be designed to switch between high and low voltage levels within every frame time of the display panel and at the end of every frame time of the display panel to control the shift of the threshold voltage of the components in the shift register, thus alleviating the aging of the threshold voltage. Therefore, the design may effectively improve the reliability of the shift register.

Although the present invention has been disclosed above by the embodiments, these embodiments are not intended to limit the present invention, and those skilled in the art may make modifications and variations without departing from the spirit and the scope of the present invention. Therefore, the scope of protection of the present invention shall be as defined in the attached claims.

What is claimed is:

1. A display device, comprising:
a display panel; and
shift registers from a first level to an N^{th} level configured to drive the display panel, wherein an i^{th} level of the shift registers from the first level to the N^{th} level comprises:
a pull-up unit driving stage receiving a first input signal and a second input signal, and outputting a pull-up driving signal via a first node according to the first input signal and the second input signal;
a pull-up unit coupled to the pull-up unit driving stage, receiving the pull-up driving signal and a plurality of clock signals, and outputting a scanning signal from the i^{th} level via a second node according to the pull-up driving signal and the clock signals; and
a discharge unit coupled to the pull-up unit driving stage and the pull-up unit, receiving the pull-up driving signal, a first discharge control signal, and a second discharge control signal, and controlling whether to pull-down and maintain the scanning signal from the i^{th} level at a reference potential according to the pull-up driving signal, the first discharge control signal, and the second discharge control signal;
wherein the first discharge control signal and the second discharge control signal switch between high and low voltage levels within every frame time of the display panel and at an end of every frame time of the display panel.

2. The display device of claim 1, wherein a voltage switching time point of the second input signal is prior to a voltage switching time point of the first input signal within every frame time.

3. The display device of claim 1, wherein a voltage switching time point of the second input signal is substantially the same as voltage switching time points of the first discharge control signal and the second discharge control signal within every frame time.

4. The display device of claim 1, wherein the first discharge control signal and the second discharge control signal switching between high and low voltage levels within every frame time of the display panel and at the end of every frame time of the display panel comprises the first discharge control signal and the second discharge control signal switching between high and low voltage levels at a first time point of a blanking period of every frame time of the display panel.

5. The display device of claim 1, wherein the first discharge control signal and the second discharge control signal switch between high and low voltage levels within every frame time of the display panel and at the end of every frame time of the display panel comprises the first discharge control signal or the second discharge control signal switching between high and low voltage levels at a second time point of a blanking period of every frame time of the display panel.

6. The display device of claim 1, wherein a signal period of the clock signals is 12 data writing times, wherein the data writing time is defined as the time spent by every one of the shift registers from the first level to the N^{th} level driving a corresponding pixel row of the display device within every frame time.

7. The display device of claim 1, wherein a voltage switching time point of the first discharge control signal and a voltage switching time point of the second discharge control signal are about 2.5 microseconds apart.

8. The display device of claim 1, wherein signal periods of the first discharge control signal and the second discharge control signal are about 2 seconds.

9. The display device of claim 1, wherein there is a data holding time between the first discharge control signal and the scanning signal from the i^{th} level, or between the second discharge control signal and the scanning signal from the i^{th} level, and the data holding time is 2.5 microseconds.

10. The display device of claim 1, wherein a signal period of the clock signals is 16 data writing times, wherein the data writing time is defined as the time spent by every one of the shift registers from the first level to the N^{th} level driving a corresponding pixel row of the display device within every frame time.

11. The display device of claim 1, further comprising:
a reset unit coupled to the pull-up unit driving stage, the pull-up unit, and the discharge unit, receiving a reset signal, and resetting voltage levels of the first node and the second node according to the reset signal after sequentially scanning a plurality of pixel columns within every frame time of the display panel.

12. The display device of claim 11, wherein the reset unit comprises:
a first transistor, wherein the reset signal is input at a control terminal of the first transistor, a first terminal of the first transistor is coupled to the reference potential, and a second terminal of the first transistor is coupled to the first node; and
a second transistor, wherein a control terminal of the second transistor is coupled to the control terminal of the first transistor, a first terminal of the second transistor is coupled to the reference potential, and a second terminal of the second transistor is coupled to the second node.

13. The display device of claim 11, wherein voltage switching time points of the first discharge control signal and the second discharge control signal are after a voltage switching time point of the second input signal, and substantially the same as a voltage switching time point of the reset signal within every frame time when the i^{th} level of the shift registers are scanned forward.

14. The display device of claim 11, wherein voltage switching time points of the first discharge control signal and the second discharge control signal are substantially the same as a voltage switching time point of the first input signal and substantially the same as a voltage switching time point of the reset signal within every frame time when the i^{th} level of the shift registers are scanned backward.

15. The display device of claim 11, wherein a voltage switching time point of the first discharge control signal is substantially the same as a voltage switching time point of the reset signal within every frame time.

16. The display device of claim 1, wherein the pull-up unit driving stage comprises:
a third transistor, wherein a control terminal of the third transistor receives the first input signal, a first terminal of the third transistor receives a forward input signal, and a second terminal of the third transistor outputs the pull-up driving signal; and
a fourth transistor, wherein a control terminal of the fourth transistor receives the second input signal, a first terminal of the fourth transistor receives a backward input signal, and a second terminal of the fourth transistor is coupled to the second terminal of the third transistor.

17. The display device of claim 1, wherein the pull-up unit comprises:
a fifth transistor, wherein a control terminal of the fifth transistor receives the pull-up driving signal, a first terminal of the fifth transistor receives the clock signals, and a second terminal of the fifth transistor outputs the scanning signal from the i^{th} level; and
a capacitor, wherein a first terminal of the capacitor is coupled to the control terminal of the fifth transistor, and a second terminal of the capacitor is coupled to the second terminal of the fifth transistor.

18. The display device of claim 17, wherein the capacitor comprises:
a first metal layer;
a second metal layer located on the first metal layer, wherein a first sub capacitor is formed between the first metal layer and the second metal layer;
a bottom electrode layer located on the first metal layer, wherein a second sub capacitor is formed between the second metal layer and the bottom electrode layer; and
a top electrode layer located on the bottom electrode layer, wherein a third sub capacitor is located between the bottom electrode layer and the top electrode layer.

19. The display device of claim 1, wherein the discharge unit comprises:
a sixth transistor, wherein the first discharge control signal is input at a control terminal and a first terminal of the sixth transistor;
a seventh transistor, wherein the second discharge control signal is input at a control terminal of the seventh transistor, the reference potential is coupled to a first terminal of the seventh transistor, and a second terminal of the seventh transistor is coupled to the second terminal of the sixth transistor;
an eighth transistor, wherein a control terminal of the eighth transistor is coupled to a third node, and a first terminal of the eighth transistor is coupled to the reference potential;
a ninth transistor, wherein a control terminal of the ninth transistor is coupled to the third node, and a first terminal of the ninth transistor is coupled to the reference potential; and
a tenth transistor, wherein a control terminal of the tenth transistor is coupled to the third node, and a second terminal of the tenth transistor is coupled to the reference potential.

20. The display device of claim 1, wherein the display device has a dual-gate pixel array structure or a triple-gate pixel array structure.
